(19) United States
(12) Patent Application Publication
(10) Pub. No.: US 2025/0376391 A1
(43) Pub. Date: Dec. 11, 2025

(54) WASTEWATER TREATMENT SYSTEM AND WASTEWATER TREATMENT METHOD USING THEREOF

(71) Applicant: Samsung Electronics Co., Ltd., Suwon-si (KR)

(72) Inventors: Minji Kim, Suwon-si (KR); Sanghyun Jeong, Busan-si (KR); Soojin Shim, Suwon-si (KR); Jehun Kim, Suwon-si (KR); Wooram Lee, Suwon-si (KR); Jieun Lee, Busan-si (KR); Jiwon Kong, Busan-si (KR); Hyeonseok Jeong, Busan-si (KR); Hyuk Cha, Busan-si (KR); Eunseo Choi, Busan-si (KR)

(73) Assignees: Samsung Electronics Co., Ltd., Suwon-si (KR); Pusan National University Industry-University Cooperation Foundation, Busan (KR)

(21) Appl. No.: 19/188,156

(22) Filed: Apr. 24, 2025

(30) Foreign Application Priority Data
Jun. 10, 2024 (KR) 10-2024-0075288
Feb. 18, 2025 (KR) 10-2025-0020971

(51) Int. Cl. C02F 1/52; C02F 1/56; C02F 1/66; C02F 9/00; C02F 101/14

(52) U.S. Cl. CPC C02F 1/5245; C02F 1/5209; C02F 1/5281; C02F 1/56; C02F 1/66; C02F 9/00; C02F 2101/14; C02F 2209/06; C02F 2209/44

(57) ABSTRACT

Provided is a wastewater treatment system of treating fluorine-containing wastewater, the wastewater treatment system including a calcium carbonate demand meter configured to measure the concentration of fluorine ions in fluorine-containing wastewater, a first reaction tank configured to receive the fluorine-containing wastewater from a reservoir, a calcium carbonate input device configured to input calcium carbonate into the fluorine-containing wastewater in the first reaction tank, and to calculate an input amount of the calcium carbonate from the concentration of the fluorine ions, a first stirring device configured to stir the fluorine-containing wastewater with the calcium carbonate in the first reaction tank to form first treated water, a second reaction tank configured to receive first treated water from the first reaction tank, a polymer material input device configured to input a polymer material to the first treated water in the second reaction tank, a second stirring device configured to stir the first treated water with the polymer material in the second reaction tank to form second treated water, and a precipitation tank configured to receive second treated water from the second reaction tank and to precipitate and separate sludge containing calcium fluorine from the second treated water.

### CROSS-REFERENCE TO RELATED APPLICATION

This U.S. non-provisional application claims priority under 35 U.S.C. § 119 to Korean Patent Application No. 10-2024-0075288, filed on Jun. 10, 2024 and to Korean Patent Application No. 10-2025-0020971 filed on Feb. 18, 2025, in the Korean Intellectual Property Office, the disclosures of which are incorporated by reference herein in their entireties.

### BACKGROUND

The inventive concept relates to a wastewater treatment system and a wastewater treatment method using the same, and more specifically, to fluorine-containing wastewater treatment method capable of lowering the fluorine concentration of final treated water to 15 mg/L or less, and further lowering the fluorine concentration of final treated water to 1 mg/L or less, which is the legal discharge allowance standard, even when the wastewater contains a high concentration of fluorine and fluorine compounds.

Fluorine is a useful substance that is used in large quantities in various industrial fields, but fluorine is also a harmful substance to the human body and the environment, so fluorine contained in various industrial wastewater is strictly regulated.

In particular, wastewater containing fluorine is generated by the use of hydrogen fluorine (HF) at semiconductor and electronics industrial sites, and fluorine in fluorine-containing wastewater is treated and discharged to 15 mg/L or less, which is the legal discharge allowance standard of wastewater treatment facilities. In general, to treat fluorine-containing wastewater, coagulation, flocculation, and precipitation methods using slaked lime (Ca(OH)₂) are used. For example, in the case of treating fluorine-containing wastewater using slaked lime, a chemical reaction as shown in Formula 1 below may occur.

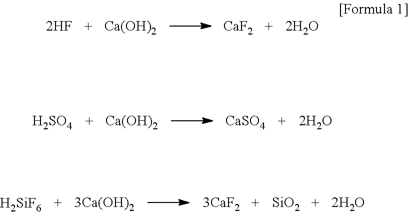

However, as the hydrogen ion concentration index (pH) of fluorine-containing wastewater exceeded about 8.5 due to the strong alkaline slaked lime, a separate acidic chemical was required to adjust the pH of fluorine-containing wastewater to about a pH of 5.8 to about a pH of 8.6, which is the legal discharge allowance standard.

In this case, there was a problem of generating excess chloride ions (Cl⁻), excess sulfate ions (SO₄²⁻), and excess sludge using acidic chemicals. In addition, even when calcium chloride (CaCl₂)) is used to treat fluorine-containing wastewater, there was a problem that a large amount of chloride ions (Cl⁻) are generated by calcium chloride (CaCl₂)).

### SUMMARY

The inventive concept provides a wastewater treatment system in which calcium carbonate (CaCO₃) is used to treat fluorine contained in fluorine-containing wastewater, and which is capable of lowering the fluorine concentration to 1 mg/L or less and lowering the sulfate ion concentration to 0.06 to 0.1 times or less than the sulfate ion concentration contained in the initial fluorine-containing wastewater.

In example embodiments, calcium carbonate is added in an appropriate amount to the fluorine-containing wastewater, and the calcium carbonate are stirred with the fluorine-containing wastewater for an appropriate stirring time and an appropriate stirring intensity. According to example embodiments, fluorine-containing wastewater is treated using calcium carbonate, according to example embodiments only calcium carbonate, and no slaked lime is used.

The technical idea of the inventive concept is not limited to the above, and other embodiments not mentioned may be clearly understood by those of ordinary skill in the art from the following description.

According to an aspect of the inventive concept, there is provided a wastewater treatment system of treating fluorine-containing wastewater, the wastewater treatment system including a calcium carbonate demand meter configured to measure the concentration of fluorine ions in fluorine-containing wastewater, a first reaction tank configured to receive the fluorine-containing wastewater from a reservoir, through a wastewater transfer pipe, a calcium carbonate input device configured to input calcium carbonate into the fluorine-containing wastewater in the first reaction tank, and to calculate an input amount of the calcium carbonate from the concentration of the fluorine ions, a first stirring device configured to stir the fluorine-containing wastewater with the calcium carbonate in the first reaction tank to form first treated water, a second reaction tank configured to receive first treated water from the first reaction tank through a first pipe, a polymer material input device configured to input a polymer material to the first treated water in the second reaction tank, a second stirring device configured to stir the first treated water with the polymer material in the second reaction tank to form second treated water, and a precipitation tank configured to receive second treated water from the second reaction tank through a second pipe and to precipitate and separate sludge containing calcium fluorine from the second treated water.

According to another aspect of the inventive concept, there is provided a wastewater treatment system of treating fluorine-containing wastewater, the wastewater treatment system including a calcium carbonate demand meter configured to measure the concentration of fluorine ions in the fluorine-containing wastewater in a reservoir in which the fluorine-containing wastewater is stored, a calcium carbonate input device configured to input calcium carbonate into the fluorine-containing wastewater in a first reaction tank to form first treated water, in which the fluorine-containing wastewater is supplied from the reservoir to the first reaction tank through a wastewater transfer pipe, and to calculate an input amount of the calcium carbonate from the concentration of the fluorine ions, a flocculation aid input device configured to input a flocculation aid into the first treated water in a second reaction tank in a second reacting tank to form second treated water, in which the first treated water is supplied from the first reaction tank to the second reaction tank through a first pipe, a polymer material input device configured to input a polymer material into the second treated water in a third reaction tank to form third treated water, in which the second treated water is supplied from the second reaction tank to the third reaction tank through a second pipe, and a precipitation tank configured to receive third treated water from the third reaction tank through a third pipe, and to precipitate and separate sludge containing calcium fluorine from the third treated water.

According to another aspect of the inventive concept, there is provided a wastewater treatment system of treating fluorine-containing wastewater, the wastewater treatment system including a calcium carbonate demand meter configured to measure the molar concentration of fluorine ions in fluorine-containing wastewater, a first reaction tank configured to receive the fluorine-containing wastewater from a reservoir through a wastewater transfer pipe; a calcium carbonate input device configured to input calcium carbonate to the fluorine-containing wastewater in the first reaction tank and to control an amount of calcium carbonate input into the first reaction tank, so that the molar concentration of the calcium carbonate in the fluorine-containing wastewater has a value of 0.5 times to 2.5 times the molar concentration of the fluorine ions, a first stirring device configured to stir the fluorine-containing wastewater with the calcium carbonate in the first reaction tank at a stirring intensity of 20 sec⁻¹ to 400 sec⁻¹ for 15 minutes to 120 minutes, a second reaction tank configured to receive the first treated water from the first reaction tank through a first pipe; a polymer material input device configured to input a polymer material to the first treated water in the second reaction tank, a second stirring device configured to stir the first treated water with the polymer material in the second reaction tank resulting in second treated water, and a precipitation tank configured to receive the second treated water from the second reaction tank through a second pipe, to grow and precipitate sludge containing calcium fluoride, to separate the sludge from the second treated water, and to discharge supernatant, wherein the calcium carbonate has a particle diameter of greater than 0.6 micrometers and less than or equal to 100 micrometers.

According to another aspect of the inventive concept, there is provided a wastewater treatment method of treating fluorine-containing wastewater, the wastewater treatment method including measuring the concentration of fluorine ions contained in the fluorine-containing wastewater; calculating an amount of calcium carbonate to react with the fluorine ions to form calcium fluorine from the measured concentration of the fluorine ions, and inputting the calcium carbonate in the calculated amount; inputting a polymer material to the fluorine-containing wastewater after inputting the calcium carbonate; growing and precipitating sludge containing calcium fluorine in the fluorine-containing wastewater after inputting the polymer material; and discharging supernatant separated from the sludge by precipitating the sludge.

In aspects of the present methods, the amount of calcium carbonate is calculated such that the molar concentration of calcium carbonate in the fluorine-containing wastewater is calculated to have a value of 0.5 times to 2.5 times the molar concentration of fluorine ions. In further aspects, in the inputting of the calcium carbonate, the calcium carbonate has a particle diameter greater than 0.6 micrometers and less than or equal to 100 micrometers. Aspects of the methods may further include stirring the calcium carbonate and the fluorine-containing wastewater in a range of 20 sec⁻¹ to 400 sec⁻¹ for 15 minutes to 120 minutes after the inputting of the calcium carbonate. In aspects of the present methods, the calcium carbonate input by the calcium carbonate input device is crystallized calcium carbonate. In aspects of the present methods, the calcium carbonate input by the calcium carbonate input device is in at least one form selected from the group consisting of calcite, vaterite, and aragonite.

### BRIEF DESCRIPTION OF THE DRAWINGS

Embodiments will be more clearly understood from the following detailed description taken in conjunction with the accompanying drawings in which:

FIG. 1 is a block diagram showing a wastewater treatment system according to some embodiments; and

FIG. 2 is a flowchart showing a wastewater treatment method according to some embodiments;

FIG. 3 is a block diagram showing a wastewater treatment system according to another embodiment;

FIG. 4 is a flowchart showing a wastewater treatment method according to another embodiment;

FIG. 5 is a block diagram showing a wastewater treatment system according to another embodiment;

FIG. 6 is a graph illustrating a result of treating wastewater using a wastewater treatment system according to embodiments; and

FIG. 7 is a graph illustrating a result of treating wastewater using a wastewater treatment system according to other embodiments.

### DETAILED DESCRIPTION OF THE EMBODIMENTS

Hereinafter, embodiments of the inventive concept will be described in detail with reference to the accompanying drawings. The same reference numerals are used for the same components in the drawings, and redundant descriptions thereof will be omitted.

Ordinal numbers such as first, second, third, fourth, etc. may be used to distinguish various constitutional elements, components, regions, layers, and/or parts (collectively referred to as “elements”) from one another, but these elements should not be limited by such terms. Thus, the first element described herein may be referred to as the second element in the claim or vice versa, which does not deviate from the spirit and scope of the inventive concept.

When the term “about,” “substantially” or “approximately” is used in this specification in connection with a numerical value, it is intended that the associated numerical value includes a manufacturing or operational tolerance (e.g., +10%) around the stated numerical value. Further, regardless of whether numerical values or shapes are modified as “about” or “substantially,” it will be understood that these values and shapes should be construed as including a manufacturing or operational tolerance (e.g., +10%) around the stated numerical values or shapes.

Items described in the singular herein may be provided in plural, as can be seen, for example, in the drawings. Thus, the description of a single item that is provided in plural should be understood to be applicable to the remaining plurality of items unless context indicates otherwise.

As used herein, the terms “particle diameter” and “particle size” are intended to include a mean or median particle diameter or size, as well as individual particle diameter or particle size. Particle diameters, and mean or median particle diameters may be measured or determined by methods known to those skilled in the art.

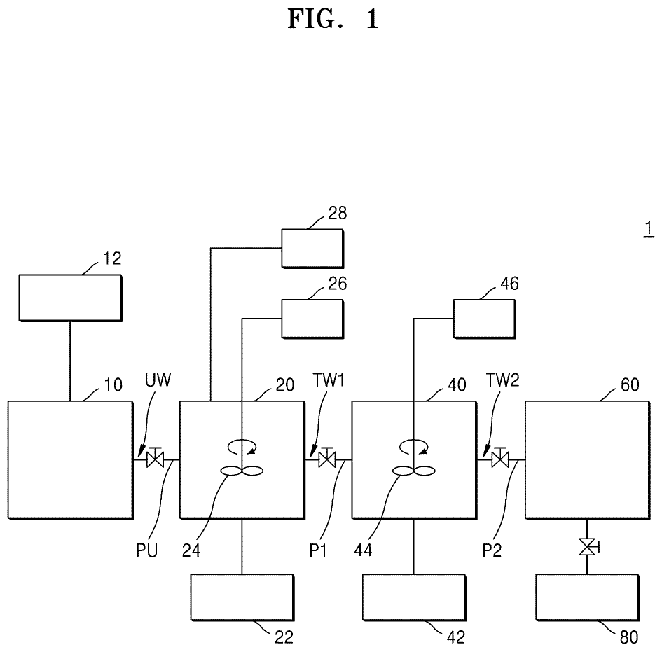

FIG. 1 is a block diagram showing a wastewater treatment system 1 according to some embodiments.

Referring to FIG. 1, the wastewater treatment system 1 according to an embodiment may be a system for treating fluorine ions (F⁻) in fluorine-containing wastewater UW. The wastewater treatment system 1 may include a reservoir 10 in which fluorine-containing wastewater UW is stored, and a calcium carbonate demand meter 12 configured to measure the concentration of fluorine ions F⁻ in the fluorine-containing wastewater UW.

The reservoir 10 may store fluorine-containing wastewater UW. The fluorine-containing wastewater UW may include pure fluorine-containing wastewater or mixed fluorine-containing wastewater. The fluorine-containing wastewater UW may include fluorine ions F, and may further include phosphate ions (PO₄³⁻), sulfate ions (SO₄²⁻), ammonium ions (NH₄⁺), or a combination thereof in another embodiment.

For example, fluorine-containing wastewater UW may occur in a diffusion process, an etching process, or a cleaning process using fluorine (F) in a semiconductor manufacturing process. In embodiments, the concentration of the material to be treated (fluorine ions (F⁻)) included in the fluorine-containing wastewater UW may be about 15 mg/L to about 2000 mg/L. According to example embodiments, the concentration of the material to be treated included in the fluorine-containing wastewater may be about 15 mg/L to about 1000 mg/L. In some embodiments, the fluorine-containing wastewater UW may be an aqueous solution having a pH of 3 or less.

The calcium carbonate demand meter 12 may measure the concentration of fluorine ions (F⁻) in fluorine-containing wastewater UW. The calcium carbonate demand meter 12 may transmit the measured concentration of fluorine ions (F⁻) to a calcium carbonate input device 22. For example, the calcium carbonate demand meter 12 may measure the molar concentration of fluorine ions (F⁻).

The wastewater treatment system 1 may include a first reaction tank 20, the calcium carbonate input device 22, a first stirring device 24, and a first control unit 26, to input calcium carbonate into the fluorine-containing wastewater UW. In some embodiments, an impurity input device 28 may be omitted.

The fluorine-containing wastewater UW may be supplied to the first reaction tank 20 along a wastewater transfer pipe PU and may stay in the first reaction tank 20 to react with calcium carbonate input by the calcium carbonate input device 22. The calcium carbonate input device 22 may calculate an input amount of calcium carbonate from the concentration of fluorine ions (F⁻) transmitted from the calcium carbonate demand meter 12. In an embodiment, the input amount of calcium carbonate may be adjusted to have a molar concentration of about 0.5 times to about 2.5 times the molar concentration of fluorine ions (F⁻) in the fluorine-containing wastewater UW. According to example embodiments, the input amount of calcium carbonate may be adjusted to have a molar concentration of 0.6 times to 1.5 times the molar concentration of fluorine ions (F⁻) in the fluorine-containing wastewater UW.

The calcium carbonate input device 22 may input calcium carbonate by as much as the calculated input amount of calcium carbonate into the first reaction tank 20 in which the fluorine-containing wastewater UW stays. In an embodiment, calcium carbonate may have a particle diameter (such as a mean or median particle diameter) greater than 0.6 micrometers and less than or equal to 100 micrometers. According to example embodiments, calcium carbonate may have a particle diameter greater than 0.6 micrometers and less than or equal to 30 micrometers, or greater than 0.6 micrometers and less than or equal to 20 micrometers.

However, this is an example, and the particle diameter of calcium carbonate may be adjusted depending on the relationship between the stirring time and the stirring intensity with respect to fluorine-containing wastewater UW. For example, when the stirring time with fluorine-containing wastewater UW is adjusted to a relatively long time or the stirring intensity is adjusted to a relatively large intensity, an appropriate fluorine ion removal rate in fluorine-containing wastewater UW may be secured, even if calcium carbonate having a relatively large particle diameter is used.

For example, when the diameter of calcium carbonate is about 1 micrometer, the calcium carbonate may be stirred at an intensity (the number of rotations per second) of about 44 sec⁻¹ to about 230 sec⁻¹ for about 30 minutes to about 60 minutes. For example, when the diameter of calcium carbonate is about 2 micrometers, the calcium carbonate may be stirred at an intensity (the number of rotations per second) of about 44 sec⁻¹ to about 230 sec⁻¹ for about 60 minutes to about 120 minutes. For example, when the calcium carbonate has a diameter of about 10 micrometers, the calcium carbonate may be stirred at an intensity (the number of rotations per second) of 230 sec⁻¹ to 500 sec⁻¹ for about 30 minutes to about 120 minutes, or at an intensity (the number of rotations per second) of about 230 sec⁻¹ for about 60 minutes.

When the particle diameter of calcium carbonate is excessively small, for example, when the particle diameter of calcium carbonate is in a range of about 0.01 micrometers to 0.6 micrometers, or 0.05 micrometers to 0.4 micrometers, fluorine treatment efficiency may be relatively low under the same stirring time and stirring intensity conditions. When the particle diameter of calcium carbonate is excessively large, for example, when the particle diameter of calcium carbonate is in a range of about 100 micrometers to about 200 micrometers, fluorine treatment efficiency is relatively low under the same stirring time and stirring intensity conditions, and to increase the fluorine treatment efficiency, especially the stirring intensity of the stirring time and stirring intensity, should be particularly increased, which may reduce economic feasibility.

In embodiments, calcium carbonate may be input in a solid or liquid phase. In embodiments, the input calcium carbonate may have a positive surface potential for fluorine-containing wastewater UW. In some embodiments, a crystallized form of calcium carbonate may be used so that calcium carbonate has a positive surface potential in the fluorine-containing wastewater UW for a reaction between calcium carbonate and fluorine ions (F⁻) in the fluorine-containing wastewater UW. For example, the crystallized form of calcium carbonate may be at least one form of calcite, vaterite, or aragonite.

The wastewater treatment system 1 may further include an impurity input device 28. In some embodiments, a small amount of impurities may be added to the fluorine-containing wastewater UW so that calcium carbonate has a positive surface potential in the fluorine-containing wastewater UW. For example, impurities may be added into the first reaction tank 20 by using the impurity input device 28. The impurities may be a metal having a less ionization tendency than calcium (Ca). For example, the impurities may include magnesium (M g), aluminum (Al), manganese (Mn), zinc (Zn), iron (Fe), nickel (Ni), or the like. The impurity input device 28 may input the impurities together with calcium carbonate or after adding calcium carbonate into the first reaction tank 20. In some other embodiments, the impurity input device 28 may be omitted.

The first stirring device 24 may stir fluorine-containing wastewater UW with calcium carbonate introduced from the calcium carbonate input device 22. The first control unit 26 connected to the first stirring device 24 may appropriately adjust the stirring time and stirring intensity of the first stirring device 24 so that calcium carbonate may react appropriately with fluorine ions F⁻.

For example, the first stirring device 24 may stir fluorine-containing wastewater UW with calcium carbonate for 15 minutes to 120 minutes, and according to example embodiments for 30 minutes to 60 minutes. For example, the first stirring device 24 may stir fluorine-containing wastewater UW with calcium carbonate at an intensity (the number of rotations per second) of 20 sec⁻¹ to 400 sec⁻¹, and according to example embodiments at an intensity (the number of rotations per second) of 40 sec⁻¹ to 300 sec⁻¹. However, this is an example, and the stirring time and stirring intensity of the first stirring device 24 may be appropriately adjusted according to the particle diameter of calcium carbonate and the input amount of calcium carbonate.

In the first reaction tank 20, hydrogen fluorine (HF) in fluorine-containing wastewater UW and calcium carbonate may react with each other to form calcium fluorine fine particles. In other words, fluorine ions F⁻ may be combined with calcium ions (Ca₂⁺) in the fluorine-containing wastewater UW to form calcium fluorine fine particles. The reaction in which calcium fluorine fine particles are formed follows Formula 2 below. Referring to Formula 2 below, carbonic acid (H₂CO₃) may be generated together with calcium fluorine fine particles.

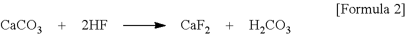

The wastewater treatment system 1 may include the second reaction tank 40 receiving the first treatment water TW1 transferred along a first treated water transfer pipe P1 from the first reaction tank 20, a polymer material input device 42, a second stirring device 44, and a second control unit 46.

The first treated water TW1 may include calcium fluorine fine particles generated by reacting fluorine ions F⁻ in the fluorine-containing wastewater UW with calcium ions Ca²⁺ generated from calcium carbonate. In embodiments, the pH of the first treated water TW1 may have a value of 6.0 to 8.0, for example, a value of 6.3 to 7.8. Calcium carbonate is used for fluorine ions F⁻ treatment, but is a relatively weak base, and carbonate (H₂CO₃) is generated, but is a relatively weak acid.

Because the pH of the first treated water TW1 may satisfy a value of a pH of 5.8 to 8.6, which is a domestic discharge allowance standard, by using calcium carbonate, which is a weak base, an aluminum-based coagulant such as aluminum sulfate (Al(SO₄)₃), aluminum chloride (AlCl₃), and an aluminum polymer (PAC), an iron-based coagulant such as iron chloride (FeCl₃) and iron sulfate (FeSO₄ and Fez (SO₄)₃), and hydrochloric acid (HCl) and sulfuric acid (H₂SO₄) may not be used. Therefore, generation of chloride ions (Cl⁻) or sulfate ions (SO₄²⁻) may be prevented.

The polymer material input device 42 may input a polymer material with the first treated water TW1 staying in the second reaction tank 40. The polymer material may form sludge together with calcium fluorine in the first treated water TW1. For example, the polymer material may include an anionic polymer material. For example, the polymer material may include polyacrylamide (PAM), polyacrylic acid (PAA), polystyrene sulfonate (PSS), or a combination thereof.

The second stirring device 44 may stir the first treated water TW1 with the polymer material. The stirring time and stirring intensity of the second stirring device 44 may be controlled by the second control unit 46. For example, the stirring time of the second stirring device 44 may be adjusted to about 10 minutes to about 20 minutes, and the stirring intensity may be adjusted to about 150 RPM. However, this is an example, and the stirring time and stirring intensity of the second stirring device 44 may be adjusted based on the fluorine ion concentration and the polymer material concentration.

The wastewater treatment system 1 may include a precipitation tank 60 receiving second treated water TW2 transferred along a second treated water transfer pipe P2 from the second reaction tank 40. Sludges containing a polymer material and calcium fluorine may be grown and precipitated in the precipitation tank 60, and the precipitated sludges may be transferred to a dehydrator 80. The precipitation tank 60 may separate sludge from supernatant, for example, using only a precipitation method using gravity. Final treated water, which is formed by separating sludge from the second treated water TW2, may be discharged from the precipitation tank 60 to the outside.

The wastewater treatment system 1 may include the dehydrator 80 for dehydrating the sludge grown in the precipitation tank 60. The dehydrator 80 may solid-liquid separate the input sludge, the solid component of sludge in the dehydrator 80 is formed into a sludge cake, and the dehydrated filtrate may be introduced back into the first reaction tank 20 together with fluorine-containing wastewater UW or discharged to the outside together with final treated water.

According to an example wastewater treatment system 1 of the inventive concept, fluorine-containing wastewater is treated using only calcium carbonate, and calcium carbonate is input in an appropriate amount and size to fluorine-containing wastewater, and the calcium carbonate and fluorine-containing wastewater are stirred for an appropriate stirring time and with an appropriate stirring intensity, so that fluorine ions contained in the fluorine-containing wastewater may be treated to about 15 mg/L or less. According to example embodiments, fluorine-containing wastewater is treated using only calcium carbonate. Because no separate acidic chemicals are used, the generation of chloride ions (Cl⁻) and sulfate ions (SO₄²⁻) may be prevented, and the amount of sludge produced may be reduced, ultimately providing a wastewater treatment system for fluorine-containing wastewater that is relatively environmentally friendly, economically advantageous, and efficient.

In addition, by checking the proper amount, proper particle diameter size, proper stirring time, and proper stirring intensity of calcium carbonate to treat fluorine-containing wastewater, precipitation alone may discharge supernatant from which sludge containing calcium fluorine is separated, providing a more economical wastewater treatment system for fluorine-containing wastewater.

Hereinafter, the fluorine removal performance of the wastewater treatment system 1 of the inventive concept will be described in more detail through Experimental Example 1 on fluorine removal performance by calcium carbonate input amount, Experimental Example 2-1 and Experimental Example 2-2 on fluorine removal performance by particle diameter size of calcium carbonate particles, Experimental Example 3 on fluorine removal performance by stirring intensity, and Experimental Example 4 on fluorine removal performance by stirring time.

Experimental Example 1, Experimental Example 2-1, Experimental Example 2-2, Experimental Example 3, and Experimental Example 4 each treated fluorine-containing wastewater having a concentration distribution as shown in Table 1 below with the wastewater treatment system of the inventive concept. Specifically, referring to Table 1 below, fluorine ions (F⁻) are contained in the fluorine-containing wastewater at 457 mg/L, phosphate ions (PO₄³⁻) that compete with fluorine ions (F⁻) in the reaction with calcium ions (Ca²⁺) are contained in the fluorine-containing wastewater at 45 mg/L, sulfate ions (SO₄²⁻) are contained in the fluorine-containing wastewater at 120 mg/L, ammonia nitrogen (NH₃—N) are contained in the fluorine-containing wastewater at 36 mg/L, and the fluorine-containing wastewater has a pH of 2.6.

TABLE 1

| Category | Before treatment |
|---|---|
| Fluorine ion concentration (mg/L) | 457 |
| Phosphate ion (PO₄³⁻) concentration (mg/L) | 45 |
| Sulfate ion (SO₄²⁻) concentration (mg/L) | 120 |
| Ammonia nitrogen (NH₃—N) concentration | 36 |
| (mg/L) | |
| pH | 2.6 |

### Experimental Example 1

In Experimental Example 1, calcium carbonate was added to the incoming fluorine-containing wastewater (polymer material is not added), and the calcium carbonate was stirred with the fluorine-containing wastewater while the stirring intensity (speed gradient) was about 230 sec⁻¹, and the stirring time was about 60 minutes. Calcium carbonate has a diameter size of 2 micrometers and a surface potential characteristic of +20 mV, but the input amounts of calcium carbonate were adjusted differently to 2000 mg/L, 2400 mg/L, 2800 mg/L, 3200 mg/L, 3600 mg/L and 4000 mg/L, as shown in “Table 2” below. Table 2 below shows the concentration and pH of fluorine ions (F⁻), phosphate ions (PO₄³⁻), sulfate ions (SO₄²⁻), and ammonia nitrogen (NH₃—N) after treating fluorine-containing wastewater in the wastewater treatment system when the amount of calcium carbonate input varies.

TABLE 2

| | Calcium carbonate input amount (mg/L) | | | | | | |
|---|---|---|---|---|---|---|---|
| | Before | | | | | | |
| Category | treatment | 2000 | 2400 | 2800 | 3200 | 3600 | 4000 |
| Fluorine ion | 457 | 11.3 | 14.0 | 8.3 | 7.2 | 5.6 | 7.2 |
| concentration (mg/L) | | | | | | | |
| Phosphate ion (PO₄³⁻) | 45 | 1.2 | 1.2 | 1.27 | 1.37 | 1.40 | 1.43 |
| concentration (mg/L) | | | | | | | |
| Sulfate ion (SO₄²⁻) | 120 | 60 | 70 | 80 | 100 | 90 | 100 |
| concentration (mg/L) | | | | | | | |
| Ammonia nitrogen (NH₃—N) | 36 | 36 | 36 | 36 | 36 | 36 | 36 |
| concentration (mg/L) | | | | | | | |
| pH | 2.6 | 6.9 | 7.1 | 7.1 | 7.4 | 7.2 | 7.4 |
| Amount of sludge (g/L) | — | 1.25 | 1.45 | 2.26 | 2.41 | 2.71 | 3.00 |

When calcium carbonate was added to fluorine-containing wastewater at a concentration of 2000 mg/L to 4000 mg/L, the concentration of fluorine ions (F⁻) after treatment was confirmed to be 5.6 mg/L to 14.0 mg/L, and it could be confirmed that the concentration of fluorine ions (F⁻) after treatment relatively decreased as the amount of calcium carbonate added increased. In particular, when calcium carbonate was added at a concentration of 3200 mg/L to 4000 mg/L, it was confirmed that the fluorine removal efficiency was 97% to 99%. The pH of the final treated water after treatment of the fluorine-containing wastewater was 6.9 to 7.4, which was confirmed to meet the legal discharge allowance standard of pH 5.8 to 8.6.

It may be seen that the concentration of the phosphate ions (PO₄³⁻) and the sulfate ions (SO₄²⁻) after treatment relatively decreased, compared to the concentration before treatment. In addition, as the amount of calcium carbonate added increases to a concentration of 2000 mg/L to 4000 mg/L, it may be confirmed that the amount of sludge increases to 1.25 g/L to 3.00 g/L.

### Experimental Example 2-1

In Experimental Example 2-1, calcium carbonate was introduced into fluorine-containing wastewater and then stirred at an intensity (speed gradient) of 230 sec⁻¹ for 60 minutes, and then stirred at an intensity (speed gradient) of 230 sec⁻¹ with a polymer material for 10 minutes. The input amount of calcium carbonate was fixed at 2000 mg/L, but the particle diameter sizes of calcium carbonate varied at 1 micrometer, 2 micrometers, and 10 micrometers. For calcium carbonate with a diameter of 1 micrometer, the surface potential was +10 mV, for calcium carbonate with a diameter of 2 micrometers, the surface potential was +20 mV, and for calcium carbonate with a diameter of 10 micrometers, the surface potential was +17 mV. The following Table 3 shows the fluorine ion concentration according to the particle diameter size of calcium carbonate as 1 micrometer, 2 micrometers, and 10 micrometers, divided into “after calcium carbonate treatment” and “after polymer material treatment”.

TABLE 3

| | Calcium carbonate particle diameter | | | |
|---|---|---|---|---|
| | Before | | | |
| Category | treatment | 1 μm | 2 μm | 10 μm |
| After calcium carbonate treatment | 457 | 13.3 | 11.3 | 14.2 |
| Fluorine ion concentration (mg/L) | | | | |
| After polymer material treatment | 457 | 9.2 | 10.1 | 14.2 |
| Fluorine ion concentration (mg/L) | | | | |
| Moisture content (%) | — | 43.0 | 48.6 | 38.7 |

Referring to Table 3 above, fluorine ions (F⁻) were treated from an initial concentration of 457 mg/L to a concentration of 13.3 mg/L by calcium carbonate having a diameter of 1 micrometer, fluorine ions (F⁻) were treated to a concentration of 11.3 mg/L by calcium carbonate having a diameter of 2 micrometers, and fluorine ions (F⁻) were treated to a concentration of 14.2 mg/L by calcium carbonate having a diameter of 10 micrometers, confirming that these values are in compliance with the legal discharge allowance standards.

After the polymer material was added to fluorine-containing wastewater, fluorine ions (F⁻) were treated to a concentration of 9.2 mg/L when calcium carbonate of 1 micrometer diameter was added, and fluorine ions (F⁻) were treated to a concentration of 10.1 mg/L when calcium carbonate of 2 micrometers was added, thereby confirming that the throughput of fluorine ions (F⁻) was relatively increased under the condition of adding the polymer material to fluorine-containing wastewater.

In addition, when calcium carbonate with a diameter of 1 micrometer, 2 micrometers, and 10 micrometers is used, it may be confirmed that the moisture content is relatively small, ranging from 38.7% to 48.6%. It may be confirmed that the sludge volume index (SVI) has been reduced in a range of 12 mL/L to 20 mL/L for the amount of sludge generated.

### Experimental Example 2-2

In Experimental Example 2-2, calcium carbonate having diameters of 0.6 micrometers, 1 micrometer, 2 micrometers, and 10 micrometers were used and stirred at an intensity (speed gradient) of 230 sec⁻¹ for 60 minutes, and then precipitated for 30 minutes without the addition of a polymer material. The following Table 4 shows the fluorine treatment efficiency (%) for each calcium carbonate input amount, and the following “Table 5” shows the fluorine ion concentration (mg/L) for each calcium carbonate input amount.

TABLE 4

| | Input amount (mg/L) | | | | | |
|---|---|---|---|---|---|---|
| Diameter | 2000 | 2400 | 2800 | 3200 | 3600 | 4000 |
| 0.6 micrometers | 84.1% | 89.7% | 93.4% | 94.3% | 95.2% | 94.1% |
| 1 micrometer | 97.1% | 97.5% | 97.7% | 97.9% | 97.6% | 97.8% |
| 2 micrometers | 97.5% | 96.9% | 98.2% | 98.4% | 98.8% | 98.4% |
| 10 micrometers | 97.3% | 97.9% | 97.4% | 98.0% | 97.9% | 98.1% |

TABLE 5

| | Input amount (mg/L) | | | | | |
|---|---|---|---|---|---|---|
| Diameter | 2000 | 2400 | 2800 | 3200 | 3600 | 4000 |
| 0.6 micrometers | 72.5 | 47.0 | 29.2 | 25.0 | 21.3 | 26.0 |
| 1 micrometer | 13.3 | 11.3 | 10.7 | 9.7 | 10.9 | 9.8 |
| 2 micrometers | 11.3 | 14.0 | 8.3 | 7.2 | 5.6 | 7.2 |
| 10 micrometers | 12.3 | 9.5 | 11.9 | 9.3 | 9.6 | 8.9 |

Referring to Table 4 and Table 5, when the diameter of calcium carbonate is excessively small to about 0.6 micrometers, it may be confirmed that the fluorine treatment efficiency is relatively low to about 84.1% to about 94.1%, and the fluorine ion concentration in the final treated water is relatively high to about 26.0 mg/L to about 72.5 mg/L.

### Experimental Example 3

In Experimental Example 3, calcium carbonate having particle diameters of 1 micrometer, 2 micrometers, and 10 micrometers were used and stirred for 60 minutes, and the stirring intensities (speed gradient) were changed to 44 sec⁻¹, 125 sec⁻¹, and 230 sec⁻¹, respectively. The following Table 6 shows the fluorine ion concentration (mg/L) after treatment at stirring intensities (speed gradients) of 44 sec⁻¹, 125 sec⁻¹, and 230 sec⁻¹.

TABLE 6

| | | Stirring intensity | | | |
|---|---|---|---|---|---|
| | | Before | | | |
| Diameter | | treatment | 44 sec⁻¹ | 125 sec⁻¹ | 230 sec⁻¹ |
| 1 | micrometer | 457 | 8.7 | 9.5 | 9.6 |
| 2 | micrometers | 457 | 10.3 | 10.8 | 10.1 |
| 10 | micrometers | 457 | 54.0 | 16.0 | 14.2 |

Referring to Table 6 above, when calcium carbonate of 1 micrometer and calcium carbonate of 2 micrometers were used, the concentration of fluorine ions (F⁻) was treated in a range of 8.1 mg/L to 10.8 mg/L regardless of the stirring intensity, whereas in the case of calcium carbonate of 10 micrometers, the concentration of fluorine ions (F⁻) was 14.2 mg/L when the stirring intensity (speed gradient) was 230 sec⁻¹ or more, thereby satisfying the legal discharge allowance standard of 15 mg/L or less. As a result, when the diameter of calcium carbonate is relatively large at 10 micrometers or more, it may be confirmed that the stirring intensity (speed gradient) should be adjusted to be relatively large at 230 sec⁻¹ or more.

### Experimental Example 4

In Experimental Example 4, calcium carbonate having diameters of 1 micrometer, 2 micrometers, and 10 micrometers was used, in which case the stirring intensity (speed gradient) is fixed at 125 sec⁻¹ for stirring, but the stirring time was changed to 30 minutes, 45 minutes, and 60 minutes for stirring. The following Table 7 shows the fluorine ion concentration (mg/L) after treatment at stirring times of 30 minutes, 45 minutes, and 60 minutes.

TABLE 7

| | | Stirring time | | | |
|---|---|---|---|---|---|
| | | Before | | | |
| Diameter | | treatment | 30 minutes | 45 minutes | 60 minutes |
| 1 | micrometer | 457 | 9.9 | 9.5 | 9.5 |
| 2 | micrometers | 457 | 18.6 | 18.1 | 10.8 |
| 10 | micrometers | 457 | 32.0 | 20.0 | 16.0 |

Referring to Table 7 above, in the case of using calcium carbonate having a diameter of 1 micrometer, fluorine ion concentration was treated in a range of 9.5 mg/L to 9.9 mg/L regardless of the length of the stirring time, whereas in the case of calcium carbonate having a diameter of 2 micrometers, fluorine ion concentration was 10.8 mg/L when the stirring time was 60 minutes or more, thereby satisfying the legal discharge allowance standard of 15 mg/L or less.

In addition, in the case of calcium carbonate with a diameter of 10 micrometers, the concentration of fluorine ions is in a range of 16.0 mg/L to 32 mg/L, which does not meet the legal discharge allowance standard of 15 mg/L or less. As a result, when the diameter of calcium carbonate is relatively large at 10 micrometers or more, it may be confirmed that the stirring intensity (speed gradient) should be adjusted to be relatively large at about 230 sec⁻¹ or more.

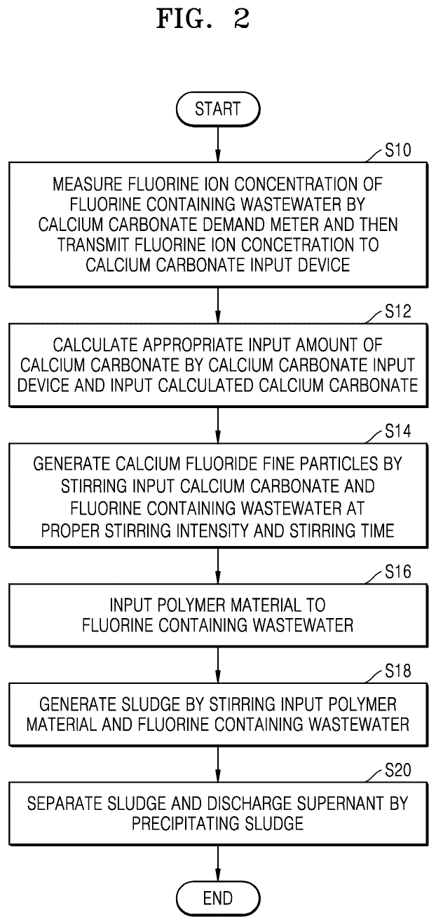

FIG. 2 is a flowchart showing a wastewater treatment method according to some embodiments.

Referring to FIG. 2. a wastewater treatment method of treating fluorine-containing wastewater, according to an embodiment, includes: measuring a fluorine ion concentration of fluorine-containing wastewater in a calcium carbonate demand meter and then transmitting the measured fluorine ion concentration to a calcium carbonate input device (S10); calculating an appropriate input amount of calcium carbonate to be added in the calcium carbonate input device and adding calcium carbonate (S12); stirring the added calcium carbonate and fluorine-containing wastewater with an appropriate stirring intensity and stirring time to create calcium fluorine fine particles (S14); adding a polymer material (S16) to fluorine-containing wastewater; stirring the added polymer material with fluorine-containing wastewater to create sludge (S18); and precipitating the sludge to separate the sludge and discharge supernatant (S20).

In the calculating of an appropriate input amount of calcium carbonate in the calcium carbonate input device and the adding of calcium carbonate (S12), the molar concentration of fluorine ions (F⁻) of the appropriate input amount of calcium carbonate may be about 0.5 to about 2.5 times, or about 1 to about 2 times the molar concentration of fluorine ions (F⁻) in the fluorine-containing wastewater. Calcium carbonate may be introduced in a solid or liquid phase, and calcium carbonate in a form crystallized to have a positive surface potential in fluorine-containing wastewater may be used, or a small amount of impurities such as magnesium (M g) may be added to fluorine-containing wastewater. As the crystallized form of calcium carbonate, for example, calcite, vaterite, or aragonite form may be used. Calcium carbonate may have a particle diameter greater than 0.6 micrometers and less than or equal to 30 micrometers, or greater than 0.6 micrometers and less than or equal to 20 micrometers.

In the generating of calcium fluorine fine particles by stirring the input calcium carbonate and fluorine-containing wastewater at an appropriate stirring intensity and stirring time (S14), the appropriate stirring intensity and stirring time may be adjusted according to the particle diameter size of the input calcium carbonate. For example, when the particle diameter of calcium carbonate is about 1 micrometer, the calcium carbonate may be stirred at an intensity (the number of rotations per second) of about 44 sec⁻¹ to about 230 sec⁻¹ for about 30 minutes to about 60 minutes. For example, when the particle diameter of calcium carbonate is about 2 micrometers, the calcium carbonate may be stirred at an intensity (the number of rotations per second) of about 44 sec⁻¹ to about 230 sec⁻¹ for about 60 minutes to about 120 minutes. For example, when the calcium carbonate has a particle diameter of about 10 micrometers, the calcium carbonate may be stirred at an intensity (the number of rotations per second) of 230 sec⁻¹ to 500 sec⁻¹ for about 30 minutes to about 120 minutes, or at an intensity (the number of rotations per second) of about 230 sec⁻¹ for about 60 minutes.

In the adding of a polymer material to fluorine-containing wastewater (S16), the polymer material may include an anionic polymer material. For example, the polymer material may include polyacrylamide (PAM), polyacrylic acid (PAA), polystyrene sulfonate (PSS), or a combination thereof.

In the generating of sludge by stirring the introduced polymer material and fluorine-containing wastewater operation (S18), for example, the stirring time may be adjusted to about 10 minutes to about 20 minutes, and the stirring intensity may be controlled to about 150 RPM. However, the stirring time and the stirring intensity may be appropriately controlled considering the amount of polymer material added and the fluorine ion concentration.

In the precipitating of sludge to separate sludge and discharge supernatant step (S20), the separated sludge may be dehydrated to form a solid component into a sludge cake, and the dehydrated filtrate may be separated from the sludge cake and discharged to the outside.

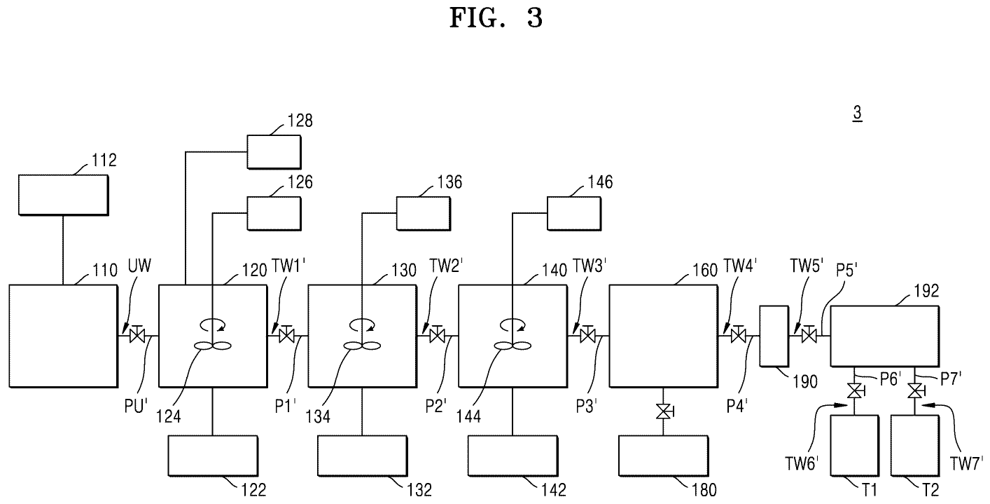

FIG. 3 is a block diagram showing a wastewater treatment system 3 according to another embodiment.

Because the wastewater treatment system 3 described with reference to FIG. 3 is generally configured similarly to the wastewater treatment system 1 described above with reference to FIG. 1, differences are described in detail below and repetitive description of shared features may be omitted.

Referring to FIG. 3, the wastewater treatment system 3 may include a reservoir 110 in which fluorine-containing wastewater UW is stored, and a calcium carbonate demand meter 112 configured to measure the concentration of fluorine ions F⁻ in the fluorine-containing wastewater UW. The wastewater treatment system 3 may include a first reaction tank 120, a calcium carbonate input device 122, a first stirring device 124, and a first control unit 126, to input calcium carbonate into the fluorine-containing wastewater UW. In some embodiments, an impurity input device 128 may be omitted. The reservoir 110, the calcium carbonate demand meter 112, the calcium carbonate input device 122, the first stirring device 124, and the first control unit 126 of the wastewater treatment system 3 described with respect to FIG. 3 may be configured in the same manner as the reservoir 10, the calcium carbonate demand meter 12, the calcium carbonate input device 22, the first stirring device 24, and the first control unit 26 described with respect to FIG.

The wastewater treatment system 3 may include a second reaction tank 130 receiving the first treatment water TW1′ transferred along a first treated water transfer pipe P1′ from the first reaction tank 120, a flocculation aid input device 132, a second stirring device 134, and a second control unit 136.

The first treated water TW1′ may include calcium fluorine fine particles generated by reacting fluorine ions F⁻ in the fluorine-containing wastewater UW with calcium ions Ca²⁺ generated from calcium carbonate. In embodiments, the pH of the first treated water TW1′ may have a value of 6.0 to 8.0, for example, a value of 6.3 to 7.8. Calcium carbonate is used for fluorine ions F-treatment, but is a relatively weak base, and carbonate (H₂CO₃) is generated, but is a relatively weak acid.

The flocculation aid input device 132 may input a flocculation aid into the first treatment water TW1′. The flocculation aid may include a metal oxide or a metal sulfate salt. For example, the flocculation aid may include one or more of an iron oxide (Fe₃O₄), iron sulfate (Fe₂(SO₄)₃), or magnesium sulfate (MgSO₄).

In embodiments, an input amount of the flocculation aid may be adjusted so that the pH concentration of the first treated water TW1′ is maintained in a range of 6 to 8.

In embodiments, the flocculation aid may include iron oxide (Fe₃O₄), and the iron oxide may have a particle diameter in a range of 0.1 micrometers to 60 micrometers or in a range of 0.5 micrometers to 10 micrometers, and may be added at a concentration of about 10 mg/L to about 1000 mg/L, or about 50 mg/L to about 900 mg/L, or about 100 mg/L to about 750 mg/L, with respect to the first treated water TW1′.

In embodiments, the flocculation aid may include at least one metal sulfate salt such as iron sulfate (Fe₂(SO₄)₃) or magnesium sulfate (MgSO₄). The metal sulfate salt may be added at a concentration of about 50 mg/L to about 150 mg/L or about 70 mg/L to about 130 mg/L, with respect to the first treated water TW1′.

The added flocculation aid may promote flocculation of sludge flocs containing calcium fluoride, and may be precipitated by gravity together with the sludge flocs. As a result, the flocculation aid may greatly reduce the amount of suspended solids in the treated water, and may reduce or prevent fouling due to the accumulation of suspended solids on the surface of a nano-filtering unit 192.

In embodiments, the second stirring device 134 may stir the first treated water TW1′ with the flocculation aid. The stirring time and stirring intensity of the second stirring device 134 may be controlled by the second control unit 136. For example, the stirring time of the second stirring device 134 may be adjusted in a range of about 10 minutes to about 30 minutes, or 15 to 25 minutes, and the stirring intensity (speed gradient) may be adjusted in a range of about 100 sec⁻¹ to about 350 sec⁻¹, or in a range of about 150 sec⁻¹ to about 300 sec⁻¹. However, this is an example, and the stirring time and stirring intensity of the second stirring device 134 may be adjusted considering the concentration of the flocculation aid.

In embodiments, the wastewater treatment system 3 may include the third reaction tank 140 receiving the second treatment water TW2′ transferred along a second treated water transfer pipe P2′ from the second reaction tank 130, a polymer material input device 142, a third stirring device 144, and a third control unit 146. The polymer material input device 142, the third stirring device 144, and the third control unit 146 of the wastewater treatment system 3 may be configured in the same manner as the polymer material input device 42, the second stirring device 44, and the second control unit 46 of the wastewater treatment system 1 described with reference to FIG. 1.

In embodiments, the polymer material input device 142 may inject the polymer material with respect to the second treated water TW2′ staying in the third reaction tank 140. The polymer material may form sludge together with calcium fluorine in the second treated water TW2′. The polymer material may include a material similar to that described above in the description of FIG. 1.

In embodiments, the third stirring device 144 may stir the second treated water TW2′ with the polymer material. The stirring time and stirring intensity of the third stirring device 144 may be controlled by the third control unit 146. For example, the stirring time of the third stirring device 144 may be adjusted to about 10 minutes to about 20 minutes, and the stirring intensity may be adjusted to about 150 RPM. This is a non-limiting example, and the stirring time and stirring intensity of the third stirring device 144 may be adjusted considering the fluorine ion concentration and the polymer material concentration.

In embodiments, the wastewater treatment system 3 may include a precipitation tank 160 receiving third treated water TW3′ transferred along a third treated water transfer pipe P3′ from the third reaction tank 140. Sludges containing a polymer material and calcium fluorine may be grown and precipitated in the precipitation tank 160, and the precipitated sludges may be transferred to a dehydrator 180. The precipitation tank 160 may separate sludge from supernatant using a precipitation method using gravity. The sludge may be promoted for growth by a flocculation air and may include sludge flocs.

In embodiments, the wastewater treatment system 3 may include the dehydrator 180 for dehydrating the sludge grown in the precipitation tank 160. The dehydrator 180 may solid-liquid separate the sludge input into the dehydrator 180, the solid component of sludge in the dehydrator 180 is formed into a sludge cake, and the dehydrated filtrate may be introduced back into the first reaction tank 120 together with fluorine-containing wastewater UW or discharged to the outside together with final treated water.

In embodiments, the wastewater treatment system 3 may include a cartridge filter 190 receiving the fourth treated water TW4′ transferred along a fourth treated water transfer pipe P4′ from the precipitation tank 160 and a nano-filtering unit 192 receiving the fifth treated water TW5′ transferred along a fifth treated water transfer pipe P5′ from the cartridge filter 190.

In embodiments, the fourth treated water TW4′ may be supernatant in which sludge is separated from the third treated water TW3′. Because a separate acidic chemical is not introduced until the fourth treated water TW4′ is formed from the fluorine-containing wastewater UW, chloride ions Cl⁻ may not be additionally generated, and the concentration of the fluorine ions in the fourth treated water TW4′ may be about 15 mg/L or less. In addition, the flocculation aid promotes the growth of sludge floc, so that the concentration of suspended solids remaining in the fourth treated water TW4′ may be in a range of about 0 mg/L to about 3 mg/L.

In some embodiments, when a metal oxide, for example iron oxide, is used as the flocculation aid, the concentration of sulfate ions in the fourth treated water TW4′ may be less by about 50 mg/L than the concentration of sulfate ions in the fluorine-containing wastewater UW. In some other embodiments, when a metal sulfate salt is used as the flocculation aid, the concentration of sulfate ions in the fourth treated water TW4′ may be greater by about 30 mg/L to about 50 mg/L than the concentration of sulfate ions in the fluorine-containing wastewater UW.

In embodiments, the fourth treated water TW4′ may pass through the cartridge filter 190. The cartridge filter 190 may separate suspended solids included in the fourth treated water TW4′ from the fourth treated water TW4′. The fifth treated water TW5′ may be transferred from the cartridge filter 190 to the nano-filtering unit 192. The fifth treatment water TW5′ may be obtained by removing various suspended solids from the fourth treatment water TW4′. The fifth treated water TW5′ may pass through the nano-filtering unit 192.

In embodiments, the nano-filtering unit 192 may include a porous polymer membrane, and the porous polymer membrane may have a pore size of about 0.1 kDa to about 1 kDa, or about 0.2 kDa to about 0.8 kDa. For example, the porous polymer membrane may have a pore size of about 0.4 kDa. The porous polymer membrane may be configured in a hollow fiber type or a spiral wound type.

In embodiments, the nano-filtering unit 192 may separate fluorine ions from the fifth treated water TW5′ so that the fluorine ions contained in the fifth treated water TW5′ remain at about 1 mg/L, and separate sulfate ions from the fifth treated water TW5′ so that the sulfate ions contained in the fifth treated water TW5′ may be included at a concentration of 10% compared to the sulfate ion concentration contained in the fluorine-containing wastewater UW. In the nano-filtering unit 192, fluorine ions and sulfate ions that do not pass through the porous polymer membrane may be included in the sixth treated water TW6′, and the sixth treated water TW6′ may be transferred along a sixth treated water transfer pipe P6′ and stored in a first tank T1. The seventh treated water TW7′, in which the concentration of fluorine ions and sulfate ions is significantly lowered compared to the fifth treated water TW5′ by passing through the porous polymer membrane in the nano-filtering unit 192, may be transferred along a seventh treated water transfer pipe P7′ and stored in a second tank T2.

In embodiments, the wastewater treatment system 3 includes the nano-filtering unit 192 to extremely reduce the concentration of fluorine ions and sulfate ions. Furthermore, the nano-filtering unit 192 may be operated relatively stably by constructing the wastewater treatment system 3 so that the water to be treated passes through the nano-filtering unit 190 after the flocculation aid is input into the water to be treated and after the water to be treated passes through the cartridge filter 190.

Hereinafter, referring to Table 8 below, which analyzes the concentration of various types of ions in the water to be treated, it is specifically examined how much the concentration of fluorine ions and sulfate ions may be reduced compared to the initial fluorine-containing wastewater, by using the wastewater treatment system 3 according to example embodiments. In Table 8 below, the unit of ion concentration for each of several types of ions is mg/L. Iron oxide (Fe₃O₄) was used as a flocculation aid, and the particle diameter of the iron oxide (Fe₃O₄) used is 0.7 micrometers and the concentration is 100 mg/L.

TABLE 8

| | F⁻ | Cl⁻ | NO₃⁻ | SO₄²⁻ | Na⁺ | NH₄⁺ | K⁺ | Mg²⁺ | Ca²⁺ |
|---|---|---|---|---|---|---|---|---|---|
| Fluorine- | 329.3 | 20.2 | 8.3 | 112.7 | 16.5 | 21.8 | 3.1 | 0.3 | 3.1 |
| containing | | | | | | | | | |
| wastewater | | | | | | | | | |
| (UW) | | | | | | | | | |
| Fourth treated | 1.8 | 8.8 | 7.7 | 87.7 | 15.5 | 10.9 | 0 | 0.6 | 106.3 |
| water (TW4′) | | | | | | | | | |
| Sixth treated | 0.3 | 0.8 | 0.6 | 7.7 | 1.5 | 2.3 | 0 | 0.3 | 51.0 |
| water (TW6′) | | | | | | | | | |

Referring to Table 8, compared to the fluorine ion concentration of the fluorine-containing wastewater (UW) of about 329.3 mg/L, it may be confirmed that the fourth treated water TW4′ after calcium fluoride sludge flocs are separated in the precipitation tank 160 is about 1.8 mg/L which is the fluorine ion concentration of about 15 mg/L or less. In addition, it may be confirmed that the sixth treated water TW6′ after passing through the nano-filtering unit 192 has a fluorine ion concentration of about 0.3 mg/L.

In addition, as shown in Table 8, compared to the sulfate ion concentration of the fluorine-containing wastewater (UW) of about 112.7 mg/L, it may be confirmed that the fourth treated water TW4′ has a sulfate ion concentration of about 87.7 mg/L, and the sixth treated water TW6′ has a sulfate ion concentration of about 7.7 mg/L. In addition, chlorine ions, nitrate ions, sodium ions, sodium hydroxide ions, potassium ions, and calcium ions also have significantly lower concentrations in the sixth treated water TW6′ compared to fluorine-containing wastewater (UW).

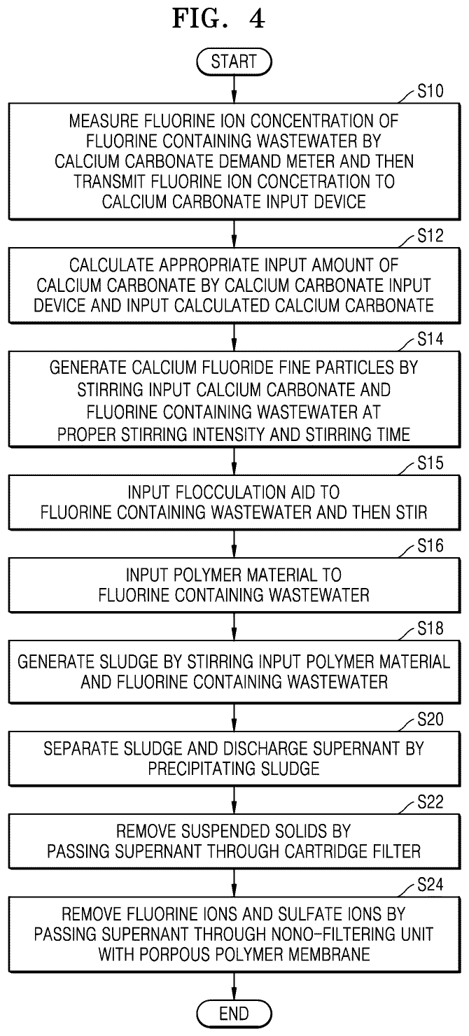

FIG. 4 is a flowchart showing a wastewater treatment method according to another embodiment. The wastewater treatment method according to another embodiment of the inventive concept described with reference to FIG. 4 is generally similar to the wastewater treatment method according to the embodiment of the inventive concept described with reference to FIG. 2, and thus differences are mainly described below and repetitive description of shared features may be omitted.

Referring to FIG. 4, a wastewater treatment method according to another embodiment of the inventive concept includes after measuring a fluorine ion concentration of fluorine-containing wastewater in a calcium carbonate demand meter, transmitting the measured fluorine ion concentration to a calcium carbonate input device (S10), adding calcium carbonate by calculating an appropriate amount of calcium carbonate in the calcium carbonate input device (S12), generating calcium fluoride particles by stirring the input calcium carbonate and fluorine-containing wastewater at an appropriate stirring intensity and stirring time (S14), adding and stirring a flocculation aid into the fluorine-containing wastewater (S15), adding a polymer material to the fluorine-containing wastewater (S16), stirring the added polymer material and fluorine-containing wastewater to generate sludge (S18), precipitating sludge to separate sludge and discharge supernatant (S20), removing the suspended solids by passing the supernatant through a cartridge filter (S22), and removing fluorine ions and sulfate ions in the supernatant by passing the supernatant through a nano-filtering unit with a porous polymer membrane (S24).

In the adding and stirring of the flocculation aid to the fluorine-containing wastewater (S15), the flocculation aid may include at least one of a metal oxide or a metal sulfate salt. For example, the flocculation aid may include iron oxide (Fe₃O₄), iron sulfate (Fe₂(SO₄)₃), or magnesium sulfate (MgSO₄). An input amount of the flocculation aid may be adjusted so that the pH concentration of the first treated water TW1′ is maintained in a range of 6 to 8. In embodiments, the flocculation aid may include iron oxide (Fe₃O₄), and the iron oxide may have a particle diameter in a range of 0.1 micrometers to 60 micrometers or in a range of 0.5 micrometers to 10 micrometers, and may be added at a concentration of about 10 mg/L to about 1000 mg/L, or about 20 mg/L to about 800 mg/L. In other embodiments, the flocculation aid may include metal sulfate salt such as iron sulfate (Fe₂(SO₄)₃) or magnesium sulfate (MgSO₄). The metal sulfate salt may be added at a concentration of about 50 mg/L to about 150 mg/L.

The added flocculation aid promotes flocculation of sludge flocs containing calcium fluoride, grows the size of the sludge flocs, and may be precipitated by gravity together with the sludge flocs. As a result, the flocculation aid may reduce or prevent fouling from occurring due to the accumulation of suspended solids on the surface of the nano-filtering unit.

In the operation S24 of removing fluorine ions and sulfate ions in the supernatant by passing the supernatant through a nano-filtering unit including a porous polymer membrane, the nano-filtering unit may include a porous polymer membrane, and the porous polymer membrane may have a pore size of about 0.1 kDa to about 1 kDa, or about 0.2 kDa to about 0.8 kDa. For example, the porous polymer membrane may have a pore size of about 0.4 kDa. The porous polymer membrane may be configured in a hollow fiber type or a spiral wound type.

The nano-filtering unit may remove fluorine ions and sulfate ions from the supernatant such that fluorine ions are included at a concentration of about 1 mg/L or less and sulfate ions are included at a concentration of 10% compared to the concentration of sulfate ions included in the fluorine-containing wastewater.

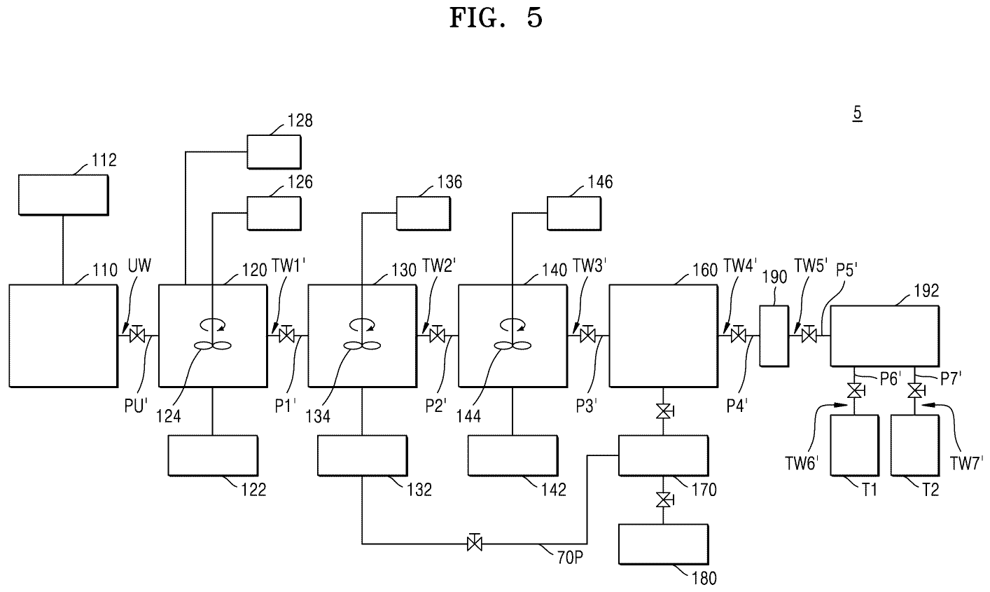

FIG. 5 is a block diagram showing a wastewater treatment system 5 according to another embodiment.

Because the wastewater treatment system 5 described with reference to FIG. 5 is generally configured similarly to the wastewater treatment system 3 described above with reference to FIG. 3, the differences are described in detail below, and repetitive description of shared features may be omitted.

Referring to FIG. 5, the wastewater treatment system 5 may include a reservoir 110 in which fluorine-containing wastewater UW is stored, and a calcium carbonate demand meter 112 configured to measure the concentration of fluorine ions F⁻ in the fluorine-containing wastewater UW. The wastewater treatment system 5 may include a first reaction tank 120, a calcium carbonate input device 122, a first stirring device 124, and a first control unit 126, in order to input calcium carbonate into the fluorine-containing wastewater UW. In some embodiments, an impurity input device 128 may be omitted.

The wastewater treatment system 5 may include the second reaction tank 130 receiving the first treatment water TW1′ from the first reaction tank 120, a flocculation aid input device 132, a second stirring device 134, and a second control unit 136.

The flocculation aid input device 132 may input a flocculation aid into the first treatment water TW1′. The flocculation aid may include a metal oxide excluding a metal sulfate salt. For example, the flocculation aid may include iron oxide (Fe₃O₄). In embodiments, an input amount of the flocculation aid may be adjusted so that the pH concentration of the first treated water TW1′ is maintained in a range of 6 to 8.

In embodiments, the flocculation aid may include iron oxide (Fe₃O₄), and the iron oxide may have a particle diameter in a range of 0.1 micrometers to 60 micrometers or in a range of 0.5 micrometers to 10 micrometers, and may be added at a concentration of about 10 mg/L to about 1000 mg/L, for example, at a concentration within about 50 mg/L to about 400 mg/L, with respect to the first treated water TW1′.

In embodiments, the wastewater treatment system 5 may include the third reaction tank 140 receiving the second treatment water TW2′ from the second reaction tank 130, a polymer material input device 142, a third stirring device 144, and a third control unit 146.

In embodiments, the wastewater treatment system 5 may include a precipitation tank 160 receiving third treated water TW3′ from the third reaction tank 140. Sludges containing a polymer material and calcium fluorine may be grown and precipitated in the precipitation tank 160, and the precipitated sludges may be transferred to a dehydrator 180 after passing through a magnetic drum 170. When the precipitated sludges pass through the magnetic drum 170, magnetic iron oxide (Fe₃O₄) is attached to the surface of the magnetic drum 170 by magnetism, and sludges from which iron oxide (Fe₃O₄) is removed may be transferred to the dehydrator 180 by gravity. The iron oxide (Fe₃O₄) attached to the surface of the magnetic drum 170 may be recovered and reused after being moved to the flocculation aid input device 132 along a magnetic material transfer pipe 70P.

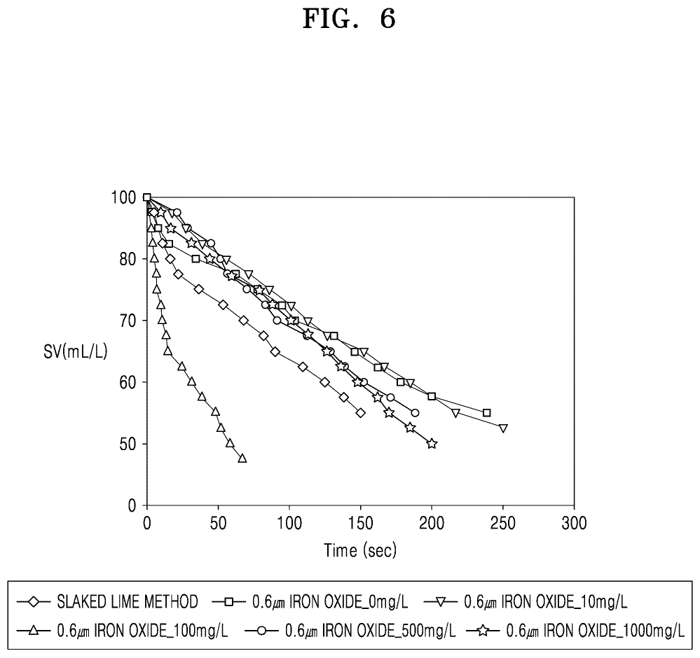

FIG. 6 is a graph illustrating a result of treating wastewater using a wastewater treatment system according to embodiments; and

Specifically, FIG. 6 is a graph showing the sedimentation rate of sludge by the input concentration of iron oxide (Fe₃O₄) using 0.6 micrometers of iron oxide (Fe₃O₄) as a flocculation aid. In reference to FIG. 6, the volume of sludge sedimented by the input concentration of iron oxide (Fe₃O₄) and the concentration of suspended solids are shown in Table 9 below. In Table 9 below, a comparative example is an example of treating a fluorine-containing wastewater by adding slaked lime (Ca(OH)₂) (slaked lime method). Iron oxide (Fe₃O₄) was added at 0 mg/L, 10 mg/L, 100 mg/L, 500 mg/L, and 1000 mg/L, with different input concentrations.

TABLE 9

| | | Addition of | Addition of | Addition of | Addition of | Addition of |
|---|---|---|---|---|---|---|
| | Comparative | 0 mg/L | 10 mg/L | 100 mg/L | 500 mg/L | 1000 mg/L |
| | example | iron oxide | iron oxide | iron oxide | iron oxide | iron oxide |
| Volume of | 15 | 7 | 5 | 2 | 6 | 2 |
| sedimented | | | | | | |
| sludge (mL/L) | | | | | | |
| Concentration | 1.5 | 8.5 | 2 | 0 | 0 | 6 |
| of suspended | | | | | | |
| solids (mg/L) | | | | | | |

Referring to FIG. 6, in a case where calcium carbonate (CaCO₃) is added without iron oxide (Fe₃O₄) compared to the case where slaked lime (Ca(OH)₂) is added (slaked lime method), it may be seen that the sludge volume (SV) per hour, that is, the sludge sedimentation rate, is slow. In addition, referring to Table 9, it may be seen that the concentration of suspended solids is relatively high at about 8.5 mg/L in a case where calcium carbonate (CaCO₃) is added without iron oxide (Fe₃O₄), compared to the case where the concentration of suspended solids is at about 1.5 mg/L when slaked lime (Ca(OH)₂) is added. Considering the high concentration of suspended solids when calcium carbonate (CaCO₃) is added without iron oxide (Fe₃O₄), when a nano-filtering unit containing a porous polymer membrane is introduced into the wastewater treatment system without a flocculation aid, fouling may occur frequently on the surface of the porous polymer membrane, making it difficult to operate the wastewater treatment system stably.

Referring to FIG. 6 again, comparing the case of adding slaked lime (Ca(OH)₂) with the case of adding calcium carbonate (CaCO₃) together with iron oxide (Fe₃O₄) compared to the case of adding calcium carbonate (CaCO₃) without iron oxide (Fe₃O₄), it may be seen that the sludge sedimentation rate is relatively slow when iron oxide is added at 10 mg/L, 500 mg/L and 1000 mg/L, but when iron oxide is added at 100 mg/L, the sludge sedimentation rate is relatively fast by about three times. As a result, it may be speculated that, when iron oxide is added at an appropriate concentration, a wastewater treatment system that operates at a relatively fast sludge sedimentation rate may be configured.

In addition, referring to Table 9 again, it may be seen that the concentration of suspended solids is relatively low in a range of about 0 mg/L to about 6 mg/L when calcium carbonate (CaCO₃) is added together with iron oxide (Fe₃O₄) compared to the case where the concentration of suspended solids is 8.5 mg/L when calcium carbonate (CaCO₃) is added without iron oxide (Fe₃O₄). In addition, it may be seen that the volume of sedimented sludge is relatively small when calcium carbonate (CaCO₃) is added together with iron oxide (Fe₃O₄) compared to when slaked lime (Ca(OH)₂) is added.

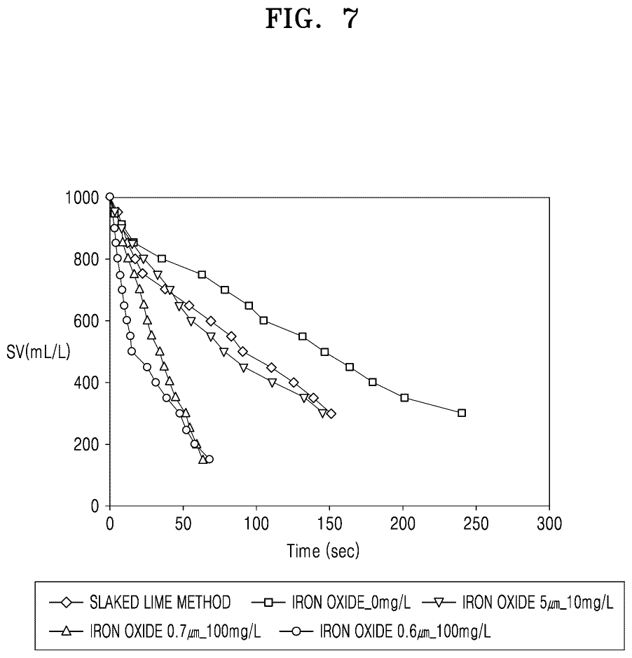

FIG. 7 is a graph illustrating a result of treating wastewater using a wastewater treatment system according to other embodiments.

Specifically, FIG. 7 is a graph showing the sedimentation rate of sludge by particle diameter size of iron oxide (Fe₃O₄) using iron oxide (Fe₃O₄) as a flocculation aid at a concentration of 100 mg/L. In reference to FIG. 7, the volume of sludge sedimented by the particle diameter size of iron oxide (Fe₃O₄) and the concentration of suspended solids are shown in Table 10 below. In Table 10 below, a comparative example is an example of treating a fluorine-containing wastewater by adding slaked lime (Ca(OH)₂) (slaked lime method). Iron oxide (Fe₃O₄) was added with 0.6 micrometers, 0.7 micrometers, and 5 micrometers with different particle diameter sizes.

TABLE 10

| | | Addition | | | |
|---|---|---|---|---|---|
| | Comparative | of 0 mg/L | 0.6 | 0.7 | 5 |
| | example | iron oxide | micrometers | micrometers | micrometers |
| Volume of | 15 | 7 | 2 | 3 | 2 |
| sedimented | | | | | |
| sludge (mL/L) | | | | | |
| Concentration of | 1.5 | 8.5 | 0 | 2.5 | 0.5 |
| suspended solids | | | | | |
| (mg/L) | | | | | |

Referring to FIG. 7 and Table 10, it may be seen that the sludge sedimentation rate is relatively slow and the concentration of suspended solids is relatively high when calcium carbonate (CaCO₃) is added without iron oxide (Fe₃O₄) compared to when slaked lime (Ca(OH)₂) is added (slaked lime method). Comparing adding slaked lime (Ca(OH)₂) with adding calcium carbonate (CaCO₃) together with iron oxide (Fe₃O₄), compared to adding calcium carbonate (CaCO₃) without iron oxide (Fe₃O₄), it may be seen that the sludge sedimentation rate is relatively fast when iron oxide (Fe₃O₄) is added at 0.6 micrometers, 0.7 micrometers, and 5 micrometers. In addition, it may be seen that as the particle diameter of iron oxide (Fe₃O₄) decreases from 5 micrometers to 0.6 micrometers, the sludge sedimentation rate increases. In addition, the smaller the particle diameter of iron oxide (Fe₃O₄), the more advantageous it may be to remove suspended solids, but even if the particle diameter of iron oxide (Fe₃O₄) is relatively large at about 5 micrometers, it may be seen that the concentration of suspended solids is relatively low at 0.5 mg/L.

While the inventive concept has been particularly shown and described herein and in the drawings with reference to embodiments thereof, it will be understood that various changes in form and details may be made, without departing from the spirit and scope of the following claims.

What is claimed is:

1. A wastewater treatment system of treating fluorine-containing wastewater, the wastewater treatment system comprising:
a calcium carbonate demand meter configured to measure the concentration of fluorine ions in fluorine-containing wastewater;
a first reaction tank configured to receive the fluorine-containing wastewater from a reservoir through a wastewater transfer pipe;
a calcium carbonate input device configured to input calcium carbonate into the fluorine-containing wastewater in the first reaction tank, and to calculate an input amount of the calcium carbonate from the concentration of the fluorine ions;
a first stirring device configured to stir the fluorine-containing wastewater with the calcium carbonate in the first reaction tank to form first treated water;
a second reaction tank configured to receive first treated water from the first reaction tank through a first pipe;
the second reaction tank having a polymer material input device;
a second stirring device configured to stir the first treated water with the polymer material in the second reaction tank to form second treated water; and
a precipitation tank configured to receive second treated water from the second reaction tank through a second pipe and to precipitate and separate sludge containing calcium fluorine from the second treated water.

2. The wastewater treatment system of claim 1, wherein
an amount of calcium carbonate calculated to be input by the calcium carbonate input device is proportional to the concentration of fluorine ions.

3. The wastewater treatment system of claim 1, wherein
the molar concentration of the calcium carbonate in the fluorine-containing wastewater is 0.5 times to 2.5 times the molar concentration of fluorine.

4. The wastewater treatment system of claim 1, wherein
a control unit that controls stirring intensity and stirring time of the first stirring device, wherein
the control unit adjusts the stirring intensity and the stirring time according to a particle diameter size of the calcium carbonate.

5. The wastewater treatment system of claim 4, wherein
the control unit increases the stirring intensity or increases the stirring time as the particle diameter size of the calcium carbonate increases.

6. The wastewater treatment system of claim 1, wherein
a stirring intensity of the first stirring device is 20 sec⁻¹ to 400 sec⁻¹.

7. The wastewater treatment system of claim 1, wherein
a stirring time of the first stirring device is 15 minutes to 120 minutes.

8. The wastewater treatment system of claim 1, wherein
the calcium carbonate input device is configured to input crystallized calcium carbonate.

9. The wastewater treatment system of claim 1, wherein
the calcium carbonate input device is configured to input calcium carbonate in at least one form selected from the group consisting of calcite, vaterite, and aragonite.

10. The wastewater treatment system of claim 1, further comprising
an impurity input device configured to input impurities containing magnesium (M g) into the first reaction tank.

11. The wastewater treatment system of claim 1, wherein
the pH of the fluorine-containing wastewater into which the calcium carbonate is input in the first reaction tank is in a range of 6.0 to 8.0.

12. A wastewater treatment system of treating fluorine-containing wastewater, the wastewater treatment system comprising:
a calcium carbonate demand meter configured to measure the concentration of fluorine ions in the fluorine-containing wastewater in a reservoir in which the fluorine-containing wastewater is stored;
a calcium carbonate input device configured to input calcium carbonate into the fluorine-containing wastewater in a first reaction tank, to form first treated water, wherein the fluorine-containing wastewater is supplied from the reservoir to the first reaction tank through a wastewater transfer pipe, and to calculate an input amount of the calcium carbonate from the concentration of the fluorine ions;
a flocculation aid input device configured to input a flocculation aid into the first treated water in a second reaction tank in a second reaction tank to form second treated water, wherein the first treated water is supplied from the first reaction tank to the second reaction tank through a first pipe;
the third reaction tank having a polymer material input device configured to input a polymer material into the second treated water to form third treated water; wherein the second treated water is supplied from the second reaction tank to the third reaction tank through a second pipe, and
a precipitation tank configured to receive third treated water from the third reaction tank through a third pipe, and to precipitate and separate sludge containing calcium fluorine from the third treated water.

13. The wastewater treatment system of claim 12, wherein
the flocculation aid input device is configured to input a flocculation aid comprising an iron oxide or a sulfuric acid-based metal salt.

14. The wastewater treatment system of claim 12, wherein
an input amount of the flocculation aid is controlled so that the second treated water maintains a pH in a range of 6 to 8.

15. The wastewater treatment system of claim 12, wherein
the flocculation aid input device is configured to input a flocculation aid comprising iron oxide, and
the wastewater treatment system further comprises a magnetic drum configured to receive the sludge precipitated from the precipitation tank and configured to separate the iron oxide from the sludge.

16. The wastewater treatment system of claim 12, further comprising
a cartridge filter configured to receive fourth treated water obtained by separating the sludge from the third treated water from the precipitation tank and configured to remove solids from the fourth treated water.

17. The wastewater treatment system of claim 16, further comprising
a nano-filtering unit configured to receive fifth treated water obtained by removing solids from the fourth treated water through the cartridge filter and configured to remove fluorine ions and sulfate ions from the fifth treated water.

18. The wastewater treatment system of claim 17, wherein
the nano-filtering unit comprises a porous polymer membrane having a pore size of 0.1 kDa to 1 kDa.

19. A wastewater treatment system of treating fluorine-containing wastewater, the wastewater treatment system comprising:
a calcium carbonate demand meter configured to measure the molar concentration of fluorine ions in fluorine-containing wastewater;
a first reaction tank configured to receive the fluorine-containing wastewater from a reservoir through a wastewater transfer pipe;
a calcium carbonate input device configured to input calcium carbonate to the fluorine-containing wastewater in the first reaction tank and to control an amount of calcium carbonate input into the first reaction tank, so that the molar concentration of the calcium carbonate in the fluorine-containing wastewater has a value of 0.5 times to 2.5 times the molar concentration of the fluorine ions;
a first stirring device configured to stir the fluorine-containing wastewater with the calcium carbonate in the first reaction tank at a stirring intensity of 20 sec⁻¹ to 400 sec⁻¹ for 15 minutes to 120 minutes resulting in first treated water;
a second reaction tank configured to receive the first treated water from the first reaction tank through a first pipe;
a second reaction tank having a polymer material;
a second stirring device configured to stir the first treated water with the polymer material in the second reaction tank resulting in second treated water; and
a precipitation tank configured to receive the second treated water from the second reacting tank through a second pipe, to grow and precipitate sludge containing calcium fluorine, to separate the sludge from the second treated water, and to discharge supernatant, wherein
the calcium carbonate has a particle diameter size of greater than 0.6 micrometers and less than or equal to 100 micrometers.

20. The wastewater treatment system of claim 19, wherein
the calcium carbonate input device is configured to input calcium carbonate in at least one form selected from the group consisting of calcite, vaterite, and aragonite.
